(19) United States
(12) Patent Application Publication
(10) Pub. No.: US 2009/0063458 A1
(43) Pub. Date: Mar. 5, 2009

(54) METHOD AND SYSTEM FOR MINIMIZING SORTING

(75) Inventors: Thomas A. BEAVIN, Milpitas, CA (US); Terence Patrick PURCELL, Springfield, IL (US)

Correspondence Address: IBM ST-SVL;SAWYER LAW GROUP LLP, 2465 E. Bayshore Road, Suite No. 406, PALO ALTO, CA, 94303, US

(73) Assignee: INTERNATIONAL BUSINESS MACHINES CORPORATION, Armonk, NY (US)

(21) Appl. No.: 11/848,858

(22) Filed: Aug. 31, 2007

(51) Int. Cl. G06F 17/30

(52) U.S. Cl. 707/5; 707/E17.017

(57) ABSTRACT

A method for minimizing the sorting of data comprises retrieving a database having an index of entries arranged according to a first, second, and third data entries. Additionally, partitioning the index of entries into a first partially-ordered list, wherein the first partially-ordered list comprises information arranged in the form of the first, second, and third data entries. The first partially-ordered list share the same first data entry. Furthermore, partitioning the index of entries into a second partially-ordered list, wherein the second partially-ordered list comprises information arranged in the form of first data entry, second data entry, third data entry. The first data entry within the second partially-ordered list is not the same as the first data entry in the first partially-ordered list. Additionally, querying the first partially-ordered list without querying the second partially-ordered list according to a set of query instructions.

### FIELD OF INVENTION

The present invention relates generally to sorting data in a database and in particular minimizing sorting and/or sorting overhead.

### BACKGROUND OF THE INVENTION

When a result set from an SQL statement is ordered, and there is no available index that supports the order, a sort is required to provide the necessary order. Before sorting the result, all qualifying rows must be retrieved. When a subset of the result is required, in many cases, a huge amount of resources must be utilized to obtain the subset. Similarly, when a full sort is performed, the result is not available to the application until the sort is completed and results are returned from the sort.

Ordering may be required for queries that include an ORDER BY clause or a GROUP BY clause. In addition, intermediate results may also be ordered to improve the performance of table joins. The challenges of sorting without avoiding a full sort are equally applicable to any of the above-mentioned scenarios.

Given that a telephone book is ordered by LASTNAME, FIRSTNAME, the following query demonstrates a worst case scenario example of this problem where there is no ordering provided by an index:

SELECT*

FROM PHONE_BOOK

ORDER BY CITY

FETCH FIRST 10 ROWS ONLY

This query is requesting the first ten entries from the phone book ordered by CITY. However, because the lowest entries for CITY could have any LASTNAME ranging from Aardvark through Zuller, the entire phonebook must be read so that the data can be sorted into CITY order such that the lowest CITY values can be determined. There is no current solution available to avoid reading the full result set when there is no index that provides ordering.

For situations where there is partial ordering provided by the index or by range based partitioning, the current implementation for database management systems treats these the same as when no ordering is provided. The full set of qualifying rows must be retrieved so that they can be sorted into sequence to match the ordering.

Thus, what is needed is a sorting method that addresses the above-identified issues. The present invention addresses such a need.

### SUMMARY OF THE INVENTION

A method for minimizing the sorting of data is disclosed. The method comprises retrieving a database having an index of entries arranged according to a first data entry, a second data entry, and a third data entry. The method further comprises partitioning the index of entries into a first partially-ordered list, wherein the first partially-ordered list comprises information arranged in the form of the first data entry, the second data entry, and the third data entry. The first partially-ordered list share the same first data entry. The method further comprises partitioning the index of entries into a second partially-ordered list, wherein the second partially-ordered list comprises information arranged in the form of first data entry, second data entry, third data entry. The first data entry within the second partially-ordered list is not the same as the first data entry in the first partially-ordered list. The method further comprises querying the first partially-ordered list without querying the second partially-ordered list according to a set of query instruction comprising:
SELECT*
FROM DIRECTORY
ORDER BY LASTNAME, CITY.
   Next, the method comprises obtaining a list of data as a result of querying the first partially-ordered list and applying predicates to the list of data to obtain a completed sorted list of data.

### BRIEF DESCRIPTION OF SEVERAL VIEWS OF THE DRAWINGS

FIG. 1 shows an index of data that is ordered by LASTNAME, FIRSTNAME

FIG. 2 shows a table of data that is not ordered by LASTNAME, CITY, but contains an index on LASTNAME, FIRSTNAME as per FIG. 1 that does provide order. To return data in LASTNAME, CITY order, a full sort may be performed.

FIG. 3 shows the index of FIG. 2 providing leading order and application fetch result size is unknown given a particular query.

FIG. 4 shows an index that provides leading order across table join, and fetching a known subset of the result given a particular query.

### DETAILED DESCRIPTION OF THE INVENTION

The present invention relates generally to sorting data in a database and in particular minimizing sorting and/or sorting overhead. The following description is presented to enable one having ordinary skill in the art to make and use the embodiment and is provided in the context of a patent application and the generic principles and features described herein will be apparent to those skilled in the art. Thus, the present embodiment is not intended to be limited to the embodiments shown, but is to be accorded the widest scope consistent with the principles and features described herein.

The present invention relates generally to sorting data in a database and in particular minimizing sorting and/or sorting overhead. By utilizing the system and method in accordance with the present invention, the overall sort requirement and costs may be reduced, which allows a sort to provide a required result set without sorting the full number of qualified rows. Alternatively, the system and method in accordance with the present invention may provide a result of a full sort incrementally to an application without waiting for the full sort to complete.

Although the present invention has been described in the context of a telephone directory, many of other types of directories could be utilized and that would be within the spirit and scope of the present invention. For example, the sorting method of the present invention may be utilized to sort data through any database including, but not limited to, customer information for retail outlets, inventory information for wholesalers, and employee information for employers.

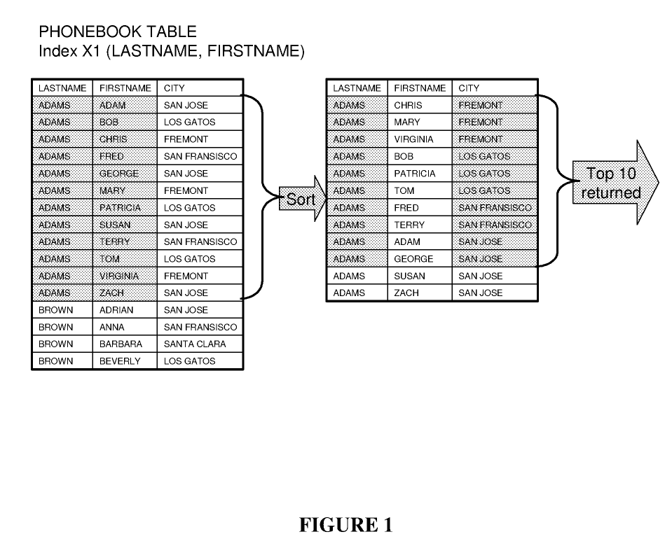

FIG. 1 shows an index of data that is ordered by LASTNAME, FIRSTNAME. The table includes additional data pertaining to one's residence in the column designated as CITY. In an embodiment, the index provides leading order and fetching a known subset of the result according to the following query:

SELECT*

FROM PHONE_BOOK

ORDER BY LASTNAME, CITY

FETCH FIRST 10 ROWS ONLY

The query ORDER BY of LASTNAME, CITY may not perfectly match the index because although the index is arranged alphabetically by LASTNAME, it is not arranged alphabetically by both LASTNAME and CITY. In an embodiment in accordance with the present invention, the following query may be sorted as follows.

First, the query requests the first 10 qualifying rows. However, there are 12 rows in the PHONE_BOOK table with LASTNAME=‘ADAMS’ which is the first “LASTNAME” in the phone book (in this example). The query must process all 12 rows, and not only the first 10 rows, because the 11^{th} and 12 rows within LASTNAME, FIRSTNAME order may result in the top 10 when ordered by LASTNAME, CITY. In this embodiment, the 11^{th} row when reordered into LASTNAME, CITY sequence becomes the 3^{rd} row.

Because the index provides a partially-ordered list with regards to LASTNAME, there is no requirement for the query to read any LASTNAME's after “ADAMS” because the top 10 LASTNAME, CITY rows are guaranteed to exist within the first 12 rows.

In another embodiment, when the query requested the FIRST 13 ROWS, the query must also read all of the LASTNAME=“BROWN” rows. The query must read enough rows within the scope of the column(s) that guarantee order, to satisfy the sort into order of the column(s) of which order is not guaranteed. Thus, whenever the result size is known, a Database Management System (DBMS) must fetch at least that number of rows, plus the number of rows until the value of the ordered column(s) changes. For example, when the query is to fetch 100 rows, and the next change of LASTNAME occurs after the 108^{th} row, then 108 rows must be retrieved since there may be rows that exist within the 101^{st}-108^{th} rows that move within the top 100 when the rows are reordered from LASTNAME, FIRSTNAME to LASTNAME, CITY sequence. When the ordered column data value (for LASTNAME in this example) changes on the nth+1 qualified row, there is no requirement to fetch past n. Also, when less than or equal to n rows qualify, there is no requirement to fetch past n.

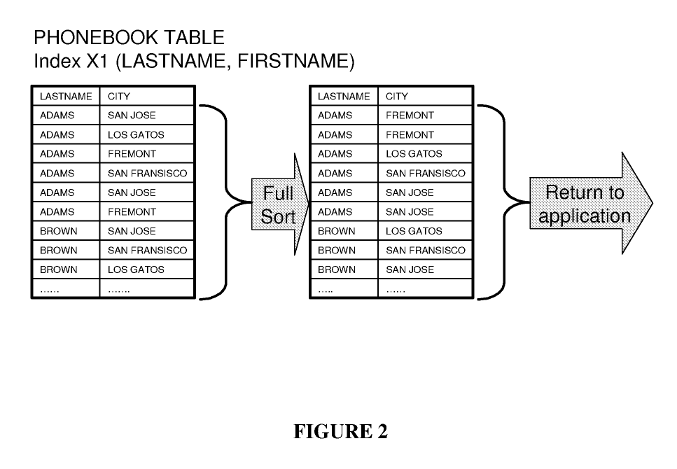

FIG. 2 shows a table of data that is ordered by LASTNAME, FIRSTNAME from FIG. 1, but not ordered by LASTNAME, CITY. Thus to return data in LASTNAME, CITY order, a full sort is performed. This embodiment differs from the previous embodiment in that the following query does not contain a FETCH FIRST n ROWS ONLY clause. Thus, the database management system does not know whether the full result set is required or a subset will be fetched by the application:

SELECT*

FROM PHONE_BOOK

ORDER BY LASTNAME, CITY

In this embodiment, the query takes advantage of the partial ordering applied to reduce the overall resources allocated to sort and also to give the application the opportunity to fetch a subset without requiring the full sort. Otherwise, when a full sort is required, the application must wait until the order is determined before the first row is returned. This is demonstrated in FIG. 2, which shows the full result being retrieved, passed to the sort routine which must complete before rows can be returned to the application or at least complete to the point where ordering is guaranteed such that rows can begin to return in order.

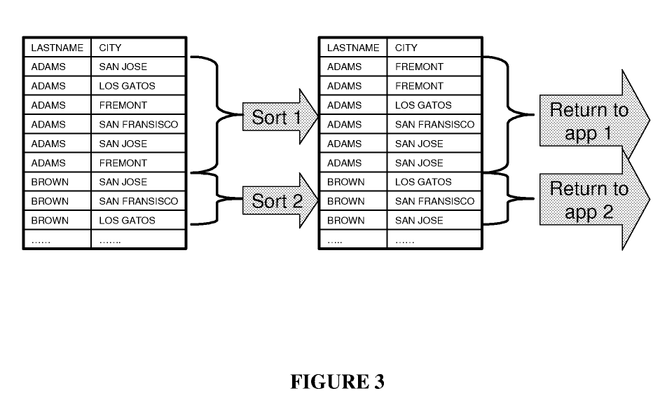

Because ordering is guaranteed by the LASTNAME column, as the data is retrieved in this sequence via the index, the data can be passed to the sort routine partially ordered. Upon change of LASTNAME, the sort routine processes the current LASTNAME group and return those to the application before processing the next LASTNAME group. This is demonstrated in FIG. 3.

Accordingly, the application will receive the first qualifying rows much quicker than when a full sort is required. When the application chooses to stop fetching, the sort routine can cease processing and will have only sorted the rows required by the application, plus the rows that were currently in progress for sorting. Even when the full result set is required, this approach to sorting may reduce resource usage enough to permit the sort to remain in memory, or to avoid excessive workfile allocations.

A Database Management System may minimize the number of rows that must be passed to the sort routine when the number of required rows can be provided to the DBMS, as in the first embodiment. Altering the query to include the FETCH FIRST n ROWS ONLY clause guarantees how many rows will be retrieved from the database. Adding the OPTIMIZE FOR n ROWS provides information to the DBMS as to the expected number of rows, which can provide guidance of the optimal sort size. However, the application may still fetch more than specified in the OPTIMIZE FOR n ROWS clause, which will require additional requests for the next “n” rows within order of LASTNAME to be sorted into CITY, within LASTNAME sequence. When altering the SQL is not possible, then providing external information via a profile table or bind parameter is an alternative.

In an alternative embodiment, an index provides leading order and additional predicates given the following query:

SELECT*

FROM PHONE_BOOK

WHERE GENDER=‘F’

ORDER BY LASTNAME CITY

FETCH FIRST 10 ROWS ONLY

This embodiment differs from the first embodiment because of the WHERE clause predicate. Predicates are not part of the original partially-ordered index and therefore as rows are retrieved from the index in partial order, the predicates are applied to the data rows such that only qualified rows are passed to the sort routine.

In another embodiment, an index provides non-leading order and fetching a known subset of the result given the following query:

SELECT*

FROM PHONE_BOOK

ORDER BY CITY

FETCH FIRST 10 ROWS ONLY

In the embodiment, for example, there may exist an index on STATE, CITY, wherein the query above requests the top 10 entries from a table which contains 100 million rows, including 50 states. The database optimizer can use the index to read the first 10 (or more until next value change) rows of each CITY value within each STATE, and only 500 rows will be passed to sort (50 groups of 10 rows each sorted separately in CITY order—or 50 groups of n rows where n covers the first change of CITY after 10 rows).

In another embodiment, an index provides order within a partition of a range partitioned tablespace, and fetching a known subset of the result given the following query:

SELECT

FROM PHONE_BOOK

ORDER BY CITY, LASTNAME

FETC FIRST 10 ROWS ONLY

In the embodiment, a table may be provided which is partitioned by STATE, of which there exists 50 STATEs (50 partitions). Additionally, there may exist a data partitioned index on CITY. As in prior examples, the index only matches the leading column of the ORDER BY clause. Because there are 50 partitions, and the index for each partition is ordered by CITY, there exists 50 ordered sets of CITY values from A through Z. There is no single index which provides one ordered set for the entire table by CITY or for the full ORDER BY clause (CITY, LASTNAME).

In the embodiment, the query requests the top entries by CITY, LASTNAME from the entire table which contains 100 million rows spread over 50 partitions. The database optimizer can use the index to read the first 10 rows of each CITY value within each partition (or more than 10 rows until the next change of CITY value within each STATE partition). Thus, only 500 rows will be passed to sort (50 groups of 10 rows each sorted separately in STATE order—or 50 groups of n rows where n covers the first change of CITY after 10 rows).

In another embodiment, for example, there may exist a table that is partitioned by CITY and a query is fetching a known subset of the result given the following query:

SELECT *

FROM PHONE_BOOK

ORDER BY CITY

FETCH FIRST 10 ROWS ONLY

In the embodiment, for example, there may exist 1000 partitions for the table partitioned by CITY. The database optimizer can choose to only read the minimum number of partitions that encompass the first 10 rows provided that the partition limit key dictates that the same CITY value cannot span partitions. Thus, only the first of 1000 partitions may need to be read in this example and all rows of the 1^{st} partition passed to the sort routine to provide order by CITY and return the first 10 rows. All rows within the subset partition(s) must be retrieved.

In another embodiment, for example, there may exist a table that is partitioned by STATE, CITY and a query is fetching a known subset of the result given the following query:

SELECT *

FROM PHONE_BOOK

ORDER BY CITY

FETCH FIRST 10 ROWS ONLY

In the embodiment, for example, there may exist 1000 partitions for the table partitioned by STATE, CITY, such that there exists 20 partitions for each of the 50 states. The database optimizer can choose to only read the minimum number of partitions that encompass the first 10 rows within each STATE. Thus, only the first of each of the 20 partitions per STATE may need to be read in this example and all rows passed to the sort routine to provide order by CITY and return the first 10 rows. In total, all rows of 50 partitions would be read as input to the sort routine to provide CITY order.

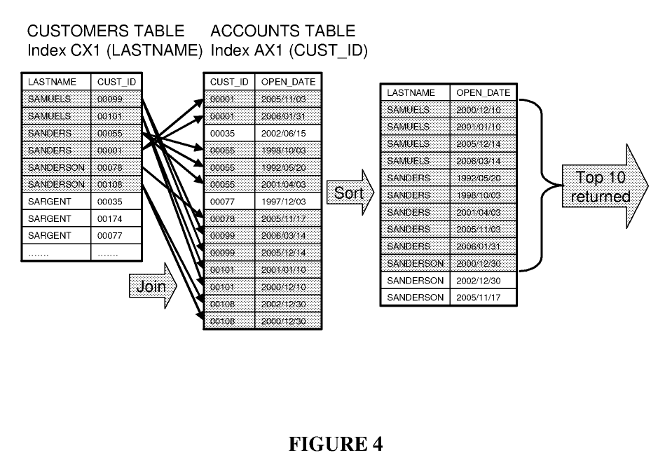

FIG. 4 shows an index that provides leading order across table join, and fetching a known subset of the result given the following query:

SELECT*

FROM CUSTOMERS C, ACCOUNTS A

WHERE C. LASTNAME LIKE ‘S %’

AND C. CUST_ID=A. CUST_ID

ORDER BY C. LASTNAME, A. OPEN_DATE

FETCH FIRST 10 ROWS ONLY

As shown in FIG. 4, an index on LASTNAME is provided on the CUSTOMERS table, and CUST_ID on the ACCOUNTS table to support the join. When the CUSTOMERS TABLE is accessed first in the join order via the index on LASTNAME, the index will guarantee the leading column sequence requirement for the ORDER BY clause. Because the query requests the first 10 rows, the number of rows accessed from the CUSTOMERS table needs to be enough to provide the required number of rows. However, when 10 rows qualify, there is another LASTNAME row with the current data value (SANDERSON) and therefore this row must also be joined to ensure that all rows are considered within the partially ordered result, such that when the sort reorders the data into C. LASTNAME, A. OPEN_DATE sequence, the correct first 10 rows are retrieved.

In another embodiment, an index provides a partial order for GROUP BY given the following query:

SELECT GENDER, LASTNAME, COUNT(*)

FROM PHONE_BOOK

GROUP BY GENDER, LASTNAME

In the embodiment, an index provides a list of data by LASTNAME. Because GROUP BY does not require the columns of the GROUP BY clause to match in exact sequence to avoid a sort as is required for ORDER BY, any one column of the GROUP BY clause that is the leading column an index may be used for partial sort avoidance as described in this invention.

Thus, partial sort avoidance for GROUP BY can reduce the result set (by summarization) earlier than is possible when a full sort is required. Thus, although the same number of rows are ultimately input to sort, the sort routine will summarize the result based upon the partial order provided by the index.

A system and method in accordance with the present invention eliminates the need for sorting a full data set before returning a subset of the qualified rows to an application. In addition, a sort method in accordance with a system and method of the present invention can be used to partition the sort of a full result set to reduce resource consumption.

In some embodiments, it is presumed that a known subset of the result set is required and thus the query simply returns enough partially-ordered rows to the sort routine to ensure the ORDER BY and FETCH requirements are satisfied. This approach may also be applied for reducing resource consumption.

For example, when a 100 million row table requires sorting, but the current resources (memory and/or work files) cannot withstand a sort of greater than 50 million records, a system and method in accordance with the present invention may be utilized to partition the sort into 10 partially-ordered results each of the 10 million rows, with each of the 10 parts executed serially in order. This example uses 10 million record sort sizes since this allows up to 5 queries of such size to execute concurrently.

A system and method in accordance with the present invention can also be extended to improve response time by separating partially-sorted results into parallel tasks to execute concurrently when resources permit.

Thus, the 10×10 million record partially-ordered subsets could execute concurrently, provided sufficient resources are available, thereby reducing the overall elapsed time compared with the 100 million row sort. This approach differs from traditional parallel sorts in that the first task is guaranteed to return the first 1/10^{th} of the data, and the second task to return the second 1/10^{th} etc. Thus, when the application chooses to fetch a subset of the result, prioritizing the parallel tasks in sequential order (thus, first parallel task has the highest priority, then second, then third) results in the high order task not executing or at least not needing to fully complete their sort.

Additionally, a system and method in accordance with the present invention demonstrates the manner in which the number of rows input into a sort can be reduced when partial ordering is provided by the leading index column, the non-leading index column, the ordered column within each partition of a range partitioned table, or simply a subset guaranteed by a range partitioned table on the ordering column.

Although the present embodiment, has been described in accordance with the embodiments shown, however, one having ordinary skill in the art will readily recognize that there could be variations to the embodiments and those variations would be within the spirit and scope of the present embodiment. For example, the sorting method of the present invention may be utilized to sort data through any database including, but not limited to, customer information for retail outlets, inventory information for wholesalers, and employee information for employers. For example, although the present invention has been described in the context of a telephone directory, many of other types of directories could be utilized and that would be within the spirit and scope of the present invention. Accordingly, many modifications may be made by one having ordinary skill in the art without departing from the spirit and scope of the appended claims.

What is claimed is:

1. A method for minimizing the sorting of data comprising:
retrieving a database having an index of entries arranged according to a first data entry, a second data entry, and a third data entry;
partitioning the index of entries into a first partially-ordered list, wherein the first partially-ordered list comprises information arranged in the form of the first data entry, the second data entry, the third data entry and wherein the first partially-ordered list share the same first data entry;
partitioning the index of entries into a second partially-ordered list, wherein the second partially-ordered list comprises information arranged in the form of first data entry, second data entry, third data entry and wherein the first data entry within the second partially-ordered list is not the same as the first data entry in the first partially-ordered list;
querying the first partially-ordered list without querying the second partially-ordered list according to a set of query instruction comprising:
SELECT*
FROM DIRECTORY
ORDER BY LASTNAME, CITY
FETCH X, N ROWS, wherein X indicates a segment of rows and wherein N is an integer, which indicates a number of rows;
obtaining a list of data as a result of querying the first partially-ordered list; and
applying predicates to the list of data to obtain a completed sort list of data.

2. The method of claim 1, wherein the index of entries includes a telephone book directory.

3. The method of claim 1, wherein the first data entry is a last name of a customer, the second data entry is a first name of a customer, and the third data entry is a city of residence of a customer.

4. A method for minimizing the sorting of data comprising:
retrieving a database having an index of telephone entries arranged according to LASTNAME, FIRSTNAME, and CITY wherein LASTNAME, FIRSTNAME is the last and first name of a customer and CITY indicates the city of residence of the customer;
partitioning the index of telephone entries into a first partially-ordered list, wherein the first partially-ordered list comprises information arranged in the form LASTNAME, FIRSTNAME, CITY and wherein the first partially-ordered list share the same LASTNAME;
partitioning the index of telephone entries into a second partially-ordered list, wherein the second partially-ordered list comprises information arranged in the form of LASTNAME, FIRSTNAME, CITY and wherein the LASTNAME within the first partially-ordered list is not the same as the LASTNAME within the second partially-ordered list;
querying the first partially-ordered list without querying the second partially-ordered list
according to a set of query instruction comprising:
SELECT*
FROM PHONE_BOOK
ORDER BY LASTNAME, CITY
FETCH X N ROWS, wherein X indicates a segment of rows and wherein N is an integer, which indicates a number of rows;
obtaining a list of data as a result of querying the first partially-ordered list; and
applying predicates to the list of data to obtain a completed sort list of data.

5. The method of claim 4 further comprising a sort requirement that includes querying the second partially-ordered list, the second partially-ordered list is queried parallel with the first partially-ordered list.

6. A computer readable storage medium encoded with a computer program for minimizing the searching of data within a telephone directory, the computer program comprising executable instructions for:
retrieving a database having an index of entries arranged according to a first data entry, a second data entry, and a third data entry;
partitioning the index of entries into a first partially-ordered list, wherein the first partially-ordered list comprises information arranged in the form of the first data entry, the second data entry, the third data entry and wherein the first partially-ordered list share the same first entry;
partitioning the index of entries into a second partially-ordered list, wherein the first partially-ordered list comprises information arranged in the form of the first data entry, the second data entry, the third data entry and wherein the first data entry within the second partially-ordered list is not the same as the first data entry within the first partially-ordered list;
querying the first partially-ordered list without querying the second partially-ordered list according to a set of query instruction comprising:
SELECT*
FROM DIRECTORY
ORDER BY LASTNAME, CITY
FETCH X N ROWS, wherein X indicates a segment of rows and wherein N is an integer, which indicates a number of rows;
obtaining a list of data as a result of querying at least one individual pre-ordered index; and
applying predicates to the list of data to obtain a completed sort list of data.
